(19) United States
(12) Patent Application Publication
(10) Pub. No.: US 2009/0174608 A1
(43) Pub. Date: Jul. 9, 2009

(54) NON-DISPERSIVE UWB ANTENNA APPARATUS USING MULTI-RESONANCE, AND METHOD FOR MANUFACTURING THE SAME

(75) Inventors: Jong-Kweon PARK, DaeJeon (KR); San-Sung Choi, DaeJeon (KR); Kwang-Roh Park, DaeJeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/324,284

(22) Filed: Nov. 26, 2008

(30) Foreign Application Priority Data
Nov. 29, 2007 (KR) 10-2007-122810

(51) Int. Cl. H01Q 1/38; H01P 11/00

(52) U.S. Cl. 343/700 MS; 29/600

(57) ABSTRACT

Provided is a non-dispersive UWB antenna using multi-resonance, which can obtain a UWB characteristic by combining a monopole radiation patch and stepped open stubs, and can obtain an improved non-dispersion characteristic by using a symmetrical structure of the monopole radiation patch and the stepped open stubs. The non-dispersive UWB antenna includes a dielectric substrate, a monopole radiation patch disposed in the center of the top surface of the dielectric substrate, stepped open stubs connected to the monopole radiation patch to induce multi-resonance, a CPW ground plane, and a CPW feed line connected to the monopole radiation patch. By using the monopole radiation patch, the stepped open stubs, and the CPW feed line, the non-dispersive UWB antenna can obtain the omni-directional radiation pattern in the frequency range (3.1-4.9 GHz) required by the system.

### CROSS-REFERENCE TO RELATED APPLICATIONS

This application claims priority under 35 U.S.C. §119 to Korean Patent Application No. P2007-122810, filed in Korea on Nov. 29, 2007, the disclosure of which is incorporated herein by reference in its entirety.

### BACKGROUND OF THE INVENTION

1. Field of the Invention

The present disclosure relates to a non-dispersive ultra-wide band (UWB) antenna apparatus using a multi-resonance, and more particularly, to a non-dispersive UWB antenna using multi-resonance, which can obtain a UWB characteristic by combining a monopole radiation patch and stepped open stubs, and can obtain an improved non-dispersion characteristic by using a symmetrical structure of the monopole radiation patch and the stepped open stubs.

2. Description of the Related Art

The ultra-wide band (UWB) technology was first developed for the military purpose by U.S. Department of Defense in 1950s. Thereafter, the UWB technology was adopted for the commercial purpose in February 2002 and standardized by the IEEE 802.15 TG3a working group for a physical layer of high-speed wireless personal area network (WPAN) in 2003. The UWB technology can transmit a large amount of digital data over a wide frequency band at a low power. Since the UWB technology uses a very short pulse period, it can be freely used without regulations by lowering a spectral density to a radiation level less than a predetermined level. Therefore, the UWB technology is widely applied in a variety fields, such as a radar system or a home network system.

A multi-band orthogonal frequency division multiplexing (MB-OFDM) and a direct sequence code division multiple access (DS-CDMA) were proposed by the IEEE 802.15.3 working group in 2003, but failed to be unified. Up to now, the MB-OFDM and the DS-CDMA have been individually developed. The MB-OFDM UWB system uses a multi-band, that is, fourteen 528-MHz bands. The bands 1, 2 and 3 (3168-4752 MHz) are defined as mandatory bands. The DS-CDMA UWB system uses a single band with an upper band and a lower band of a wide band more than 1.2 GHz, wherein a low band (3.1-4.9 GHz) is defined as a mandatory band.

A UWB communication requires a UWB antenna and performs a pulse communication, as opposing to an existing communication system. Therefore, it is necessary to develop an antenna in which a group delay characteristic is less changed and a pulse signal is less distorted. Furthermore, the antenna must be small in size, easy to manufacture, and cost-effective.

As one method for implementing a UWB antenna, a coplanar waveguide (CPW) feeding method can obtain a lower dispersion and a wider band characteristic than a microstrip line. In addition, the CWP feeding method can reduce a feed loss by integrating a ground plane and a feed line on the same surface of a substrate. Furthermore, a circuit can be miniaturized because a device can be easily attached without using via-holes. Accordingly, a manufacturing process can be simplified, and a parasitic effect caused by the via-holes can be reduced.

A wide band antenna can be implemented using a monopole and an open stub with the same line width as a feed line. Such an antenna induces multi-resonance by simply controlling a return loss characteristic according to a variation in lengths of the monopole and the open stub.

FIG. 1 is a sectional view of a related art UWB antenna using multi-resonance, especially a patch antenna using a CPW feed line.

Referring to FIG. 1, the related art UWB antenna using multi-resonance has a frequency range determined by an L-shaped monopole disposed on a substrate 100, and obtains a wide band characteristic by impedance matching within the corresponding frequency band through an I-shaped open stub 101.

However, the related art antenna can satisfy the return loss characteristic, but it is difficult to obtain an omni-directional pattern due to an asymmetric structure of the antenna. Furthermore, a high dispersion is generated because a phase of a radiation field is nonlinear. Consequently, the related art antenna is not suitable for the UWB communication that must transmit and receive pulses without distortion.

### SUMMARY

Therefore, an object of the present invention is to provide a non-dispersive UWB antenna using multi-resonance, which can obtain a UWB characteristic through the multi-resonance by combining a monopole radiation patch and stepped open stubs, and can obtain a reduced dispersion by using a symmetrical structure of the monopole radiation patch and the stepped open stubs.

To achieve these and other advantages and in accordance with the purpose(s) of the present invention as embodied and broadly described herein, a non-dispersive UWB antenna in accordance with an aspect of the present invention includes: a dielectric substrate; a monopole radiation patch disposed on one surface of the dielectric substrate; a plurality of open stubs disposed symmetrically on left and right sides of the monopole radiation patch; and a coplanar waveguide (CPW) feed line connected to a lower portion of the monopole radiation patch.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a sectional view of a related art UWB antenna using multi-resonance;

FIG. 2 is a sectional view of a non-dispersive UWB antenna using multi-resonance according to an embodiment of the present invention;

FIG. 3 is a graph illustrating a return loss of the non-dispersive UWB antenna of FIG. 2;

FIG. 4 is a graph illustrating a gain of the non-dispersive UWB antenna of FIG. 2;

FIG. 5 is a graph illustrating a group delay of the non-dispersive UWB antenna of FIG. 2;

FIG. 6 is a graph illustrating an S parameter of the non-dispersive UWB antenna of FIG. 2; and

FIGS. 7A, 7B and 7C are graphs illustrating radiation patterns of the non-dispersive UWB antenna of FIG. 2.

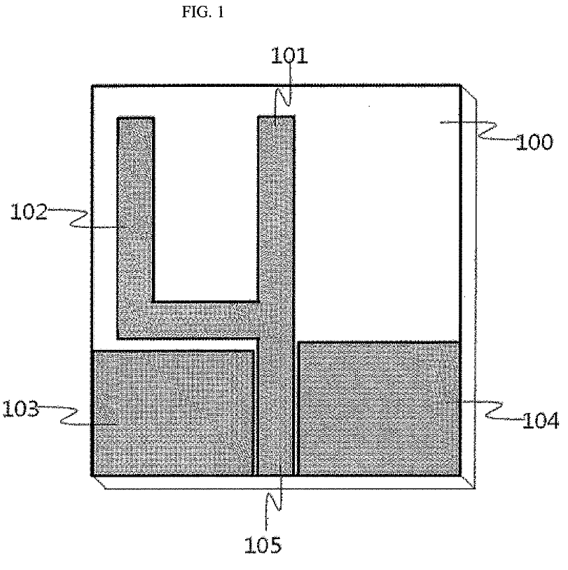

### DETAILED DESCRIPTION OF EMBODIMENTS

Hereinafter, specific embodiments will be described in detail with reference to the accompanying drawings.

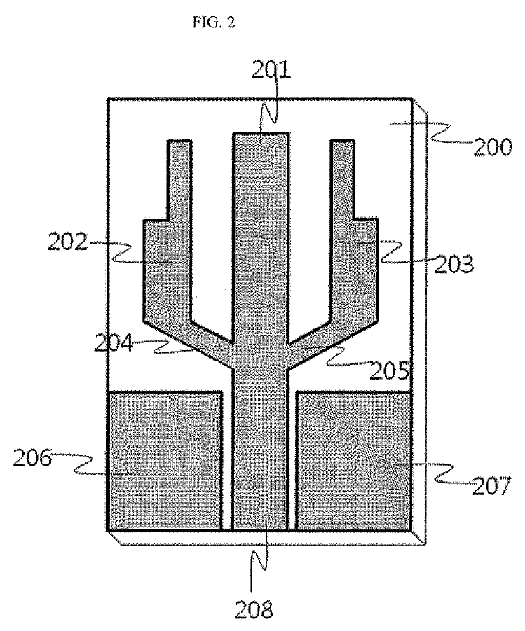

FIG. 2 is a sectional view of a non-dispersive UWB antenna using multi-resonance according to an embodiment of the present invention.

Referring to FIG. 2, the non-dispersive UWB antenna using multi-resonance includes a monopole radiation patch 201, open stubs 202, 203, 204 and 205, and a CPW feed line 208, which are disposed on a one surface of a dielectric substrate 200.

In this embodiment, the dielectric substrate 200 is an FR-4 epoxy (εᵣ=4.5, tan δ=0.025) substrate having a size of 20×30 mm² and a height of 1.6 mm, and the monopole radiation patch 201 is disposed in the center of the upper surface of the FR-4 substrate 200. The non-dispersive UWB antenna provides a multi-resonance mode by symmetrically connecting the open stubs 202, 203, 204 and 205 to left and right sides of the monopole radiation patch 201. The non-dispersive UWB antenna has a UWB characteristic by forming a groundless CPW feeding structure on a rear surface of the dielectric substrate 200.

A signal is input through the CPW feed line 208 and radiated into a free space through the monopole radiation patch 201 and the open stubs 202, 203, 204 and 205. The non-dispersive UWB antenna satisfies the frequency band of interest when an angle (θ) between the lower open stubs 204 and 205 and the monopole radiation patch 201 is in the range between about 60 degrees and about 90 degrees. The UWB characteristic is obtained by forming steps in the upper open stubs 202 and 203, and the non-dispersion characteristic is obtained by symmetrically arranging the open stubs 201, 202, 203 and 204 with respect to the monopole radiation patch 201.

The present invention is not limited to the non-dispersive UWB antenna of FIG. 2. It is apparent to those skilled in the art that various changes and modifications can be made without departing from the spirit and scope of the invention.

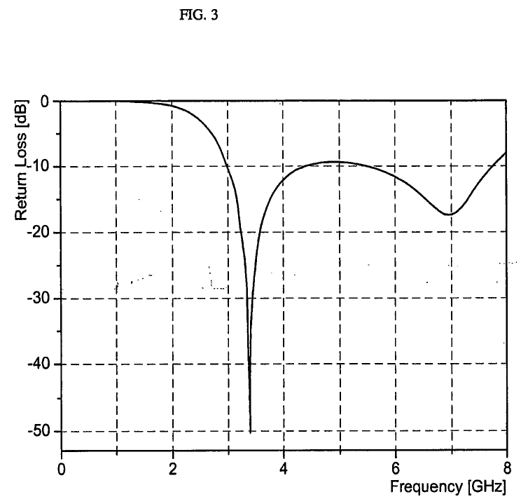

FIG. 3 is a graph illustrating a simulation result of a return loss of the non-dispersive UWB antenna of FIG. 2, which is obtained using an HFSS, a commercial electromagnetic tool.

As can be seen from FIG. 3, the non-dispersive UWB antenna using multi-resonance according to the embodiment of the present invention satisfies a required frequency band of 301-409 GHz under 10 dB.

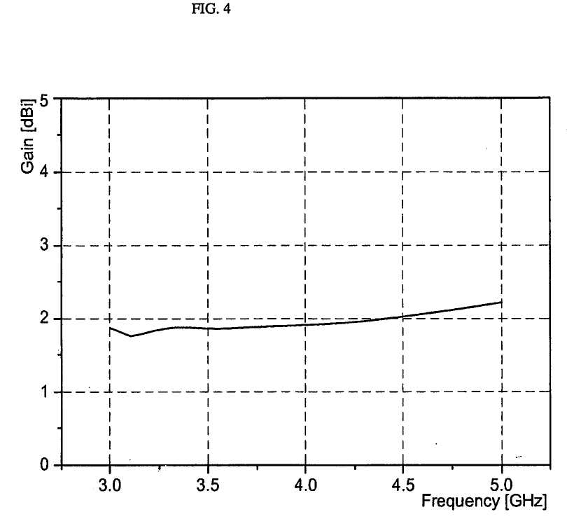

FIG. 4 is a graph illustrating an antenna gain with respect to frequency in the non-dispersive UWB antenna of FIG. 2.

As can be seen from FIG. 4, the non-dispersive UWB antenna according to the embodiment of the present invention exhibits a flat gain variation of about 0.46 dBi.

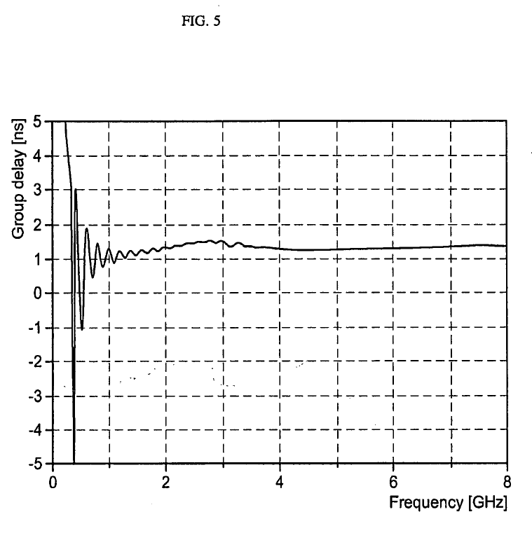

FIG. 5 is a graph illustrating a simulation result of a group delay characteristic in the non-dispersive UWB antenna of FIG. 2.

After two antennas were arranged to face each other with a spacing of 30 cm, the simulation was performed on the two antennas to check the group delay characteristic of the non-dispersive UWB antenna of FIG. 2.

Since the UWB communication performs the pulse communication, the group delay characteristic must be constant. As illustrated in FIG. 5, the non-dispersive UWB antenna according to the embodiment of the present invention has an almost constant group delay characteristic in the frequency band of interest because a variation of the group delay is about 0.23 ns.

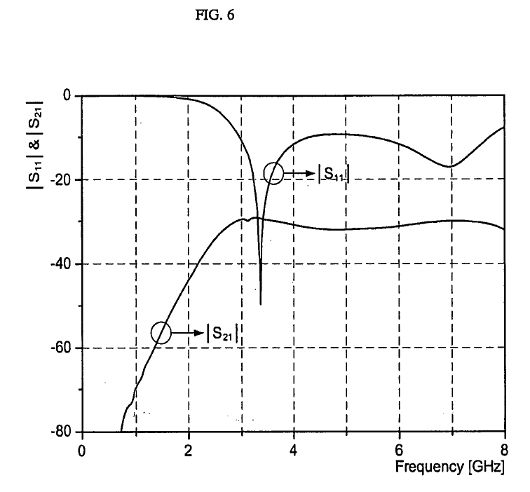

FIG. 6 is a graph illustrating a simulation result of a return loss characteristic and a radiation characteristic in the non-dispersive UWB antenna of FIG. 2.

For the appropriate UWB communication, the antenna must have a return loss characteristic of below −10 dB and a constant radiation characteristic in the frequency band of interest.

Referring to FIG. 6, the return loss characteristic of the antenna is below −10 dB in the frequency band of 3.1-4.9 GHz, and the radiation characteristic is constant. That is, the non-dispersive UWB antenna according to the embodiment of the present invention has the return loss characteristic and the radiation characteristic suitable for the UWB communication.

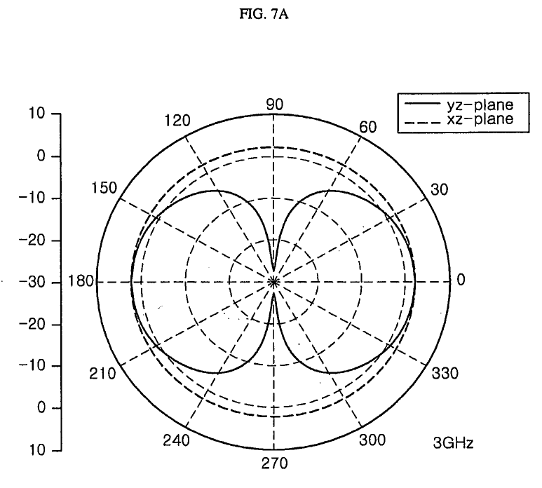

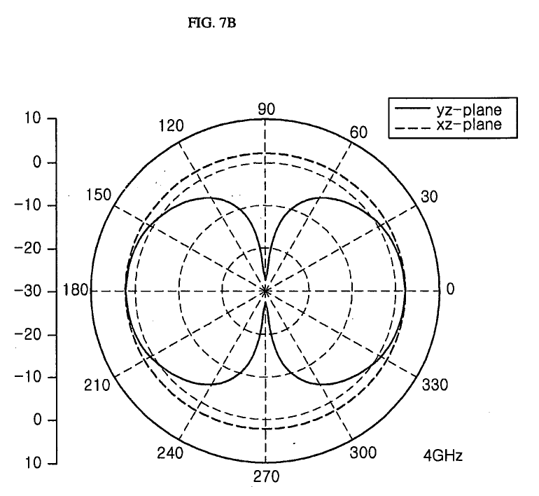

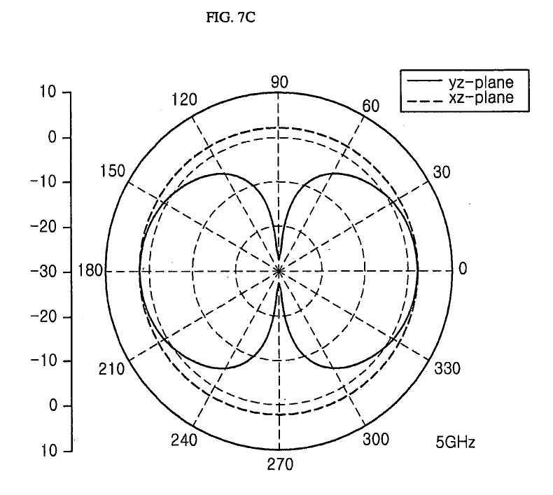

FIGS. 7A, 7B and 7C are graphs illustrating simulation results of the antenna radiation patterns with respect to frequency.

As can be seen from FIGS. 7A, 7B and 7C, the non-dispersive UWB antenna using multi-resonance according the embodiment of the present invention has the omni-directional radiation patterns in the frequency band of interest (3 GHz, 4 GHz, 5 GHz).

According to the embodiments of the present invention, the non-dispersive UWB antenna has the omni-directional pattern in the required frequency band of 3.1-4.9 GHz by using the monopole radiation patch, the stepped open stubs, and the CPW feed line.

Furthermore, the non-dispersive UWB antenna is small in size and can be easily movable. Moreover, the non-dispersive UWB antenna can be manufactured at a low cost and has the constant gain and group delay characteristics. Therefore, the non-dispersive UWB antenna is suitable for the UWB communication system that performs the pulse communication.

As the present invention may be embodied in several forms without departing from the spirit or essential characteristics thereof it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A non-dispersive ultra-wide band (UWB) antenna, comprising:
a dielectric substrate;
a monopole radiation patch disposed on one surface of the dielectric substrate;
a plurality of open stubs disposed symmetrically on left and right sides of the monopole radiation patch; and
a coplanar waveguide (CPW) feed line connected to a lower portion of the monopole radiation patch.

2. The non-dispersive UWB antenna of claim 1, wherein the open stubs are symmetrically disposed in Ψ shape on the left and right sides of the monopole radiation patch.

3. The non-dispersive UWB antenna of claim 1, wherein an angle between the lower portions of the open stubs and the monopole radiation patch is in the range between about 60 degrees and about 90 degrees.

4. The non-dispersive UWB antenna of claim 1, wherein each of the open stubs has a stepped upper portion.

5. The non-dispersive UWB antenna of claim 1, wherein the dielectric substrate comprises an FR-4 substrate.

6. The non-dispersive UWB antenna of claim 1, further comprising a groundless CPW feeding structure on a rear surface of the dielectric substrate.

7. The non-dispersive UWB antenna of claim 1, wherein the monopole radiation patch and the open stubs have a return loss characteristic of below −10 dB in a frequency band of 3.1-4.9 GHz.

8. The non-dispersive UWB antenna of claim 7, wherein the monopole radiation patch and the open stubs have an omni-directional radiation pattern in a frequency band of 3-5 GHz.

9. A method for manufacturing a non-dispersive ultra-wide band (UWB) antenna, the method comprising:
preparing a dielectric substrate;
forming a monopole radiation patch on one surface of the dielectric substrate;
forming a plurality of open stubs symmetrically on left and right sides of the monopole radiation patch; and
forming a coplanar waveguide (CPW) feed line at a lower portion of the monopole radiation patch.

10. The method of claim 9, wherein an angle between the lower portions of the open stubs and the monopole radiation patch is in the range between about 60 degrees and about 90 degrees, and each of the open stubs has a stepped upper portion.

11. The method of claim 9, further comprising forming a groundless CPW feeding structure on a rear surface of the dielectric substrate.
